(19) United States
(12) Patent Application Publication
(10) Pub. No.: US 2024/0386454 A1
(43) Pub. Date: Nov. 21, 2024

(54) Identification of Unmet Needs in a Geographic Region

(71) Applicant: Google LLC

(72) Inventors: Bruce Bahnsen, Boulder, CO (US); Yan Borisovich Mayster, Aurora, CO (US)

(73) Assignee: Google LLC, Mountain View, CA (US)

(21) Appl. No.: 18/285,580

(22) PCT Filed: Oct. 24, 2022
(86) PCT No.: PCT/US2022/047581

§ 371 Date: Oct. 4, 2023

(51) Int. Cl. G06Q 30/0204; G01C 21/36

(52) U.S. Cl. CPC G06Q 30/0205; G01C 21/3679

(57) ABSTRACT

The technology is generally directed to determining unmet needs in a geographic region. The unmet need may be a failure in that the population of the geographic region is not optimally served by the local points of interest. The unmet needs may be determined based on a failure score. The failure score may be based on navigational routes to the business and/or queries for the. The navigational routes and queries may be aggregated by the type of point of interest to determine a number of factors, such as an average distance traveled, a number of queries, an average computed distance, a time of the navigation or query, etc. The factors may be weighted and used to determine the failure score.

### BACKGROUND

A given geographical region may be underserved by businesses of certain types. For example, business offerings may be outpaced by a growing population, a demographic change, or trends have changed over time due to external factors, such as market conditions, work force needs, etc. To determine whether a geographic region is underserved, business owners may sometimes map out current locations of businesses of a particular type to gauge how many businesses of that particular type are in or nearby the geographic region. To obtain more accurate information regarding an unmet need for the type of business in the geographic region, business owners, users, entities, etc. may observe traffic patterns to and from the businesses. This may be cumbersome, requiring the owners, users, entities, etc. to observe numerous business locations and manually aggregate the data. Moreover, this does not capture user's interest in the type of businesses, particularly if there are no businesses of the particular type within the geographic region to study.

### BRIEF SUMMARY

The technology generally relates to determining unmet needs in a geographic region. The unmet need may indicate that the geographic region is not optimally served by the local businesses, services, or points of interest (POI). As will be described herein, meeting such an unmet need provides an objective reduction in average: travel time, fuel emission, transit time, travel cost and/or distance traveled for users. The unmet need may be determined based on a failure score, in which a high score may correspond to a greater unmet need as compared to a low failure score. The failure score may be determined based on queries for the type of business, service, or POI in or near the geographic region and/or navigational routes to the type of business, service, or POI originating from the geographic region or having a destination in the geographic region. The queries and navigational routes may be aggregated based on the type of business, service, or POI to determine a number of factors or travel metrics, such as average distanced traveled, average computed distance, average transit time, average travel cost, etc. The factors may be weighted and used to determine the failure score for the type of business, service, or POI. While the term “failure score” is used throughout, a failure score may be regarded as a value relating to a plurality of travel metrics, which may be aggregated and weighted as described herein.

One aspect of the technology is directed to a method, comprising: determining, by one or more processors, a type of point of interest and a geographical region, the type of point of interest being located at one or more first locations relative to the geographical region, identifying, by the one or more processors based on the type of point of interest, queries for the type of point of interest, determining, by the one or more processors based on the queries, a value of a travel metric associated with travel to the one or more first locations of the type of point of interest, and determining, by the one or more processors, a second location relative to the geographical region for the type of point of interest. A value of the travel metric associated with travel to the second location may be improved as compared to the value of the travel metric associated with travel to the one or more first locations.

The queries may be at least one of search queries or navigational queries. The travel metric may comprise one or more of average distance traveled, average computed distance, average transit time, a number of visits, a time of day of the travel, a day of week of the travel, and average travel cost. The queries may include navigational routes to the type of point of interest, each navigational route comprises a different starting location. A starting location of each navigational route may be within the geographical region or a destination of each navigational route may be within the geographical region. The navigational routes may include one or more completed navigational routes or partially completed navigational routes. The type of point of interest may correspond to a category of point of interest. The queries may originate from the geographical region or are for the type of point of interest within the geographical region.

Another aspect of the technology is directed to a system, comprising one or more processors. The one or more processors may be configured to determine a type of point of interest and a geographical region, the type of point of interest being located at one or more first locations relative to the geographical region, identify, based on the type of point of interest, queries for the type of point of interest, determine, based on the queries, a value of a travel metric associated with travel to the one or more first locations of the type of point of interest, and determine a second location relative to the geographical region for the type of point of interest. A value of the travel metric associated with travel to the second location is improved as compared to the value of the travel metric associated with travel to the one or more first locations.

Yet another aspect of the technology is directed to a computer-readable medium storing instructions, which when executed by one or more processors, cause the one or more processors to determine a type of point of interest and a geographical region, the type of point of interest being located at one or more first locations relative to the geographical region, identify, based on the type of point of interest, queries for the type of point of interest, determine, based on the queries, a value of a travel metric associated with travel to the one or more first locations of the type of point of interest, and determine a second location relative to the geographical region for the type of point of interest. A value of the travel metric associated with travel to the second location is improved as compared to the value of the travel metric associated with travel to the one or more first locations.

### BRIEF DESCRIPTION OF THE DRAWINGS

FIG. 1 is a pictorial diagram of example failure scores in accordance with aspects of the disclosure.

FIG. 2A is an example screenshot illustrating an example query for a type of business in accordance with aspects of the disclosure.

FIG. 2B is an example screenshot illustrating another example query for a type of business in accordance with aspects of the disclosure.

FIG. 3 is an example screenshot illustrating an example navigational query in accordance with aspects of the disclosure.

FIG. 4A is a pictorial diagram of an example completed navigational route in accordance with aspects of the disclosure.

FIG. 4B is a pictorial diagram of an example partially completed navigational route in accordance with aspects of the disclosure.

FIG. 5 is a pictorial diagram of an example of weighting factors to determine a failure score in accordance with aspects of the disclosure.

FIG. 6 is a pictorial diagram of an example ranking of businesses and services based on failure scores in accordance with aspects of the disclosure.

FIG. 7A is a block diagram of an example system in accordance with aspects of the disclosure.

FIG. 7B is a pictorial diagram of the example system of FIG. 7A.

FIG. 8 is a flow diagram for an example method of determining a failure score in accordance with aspects of the disclosure.

FIG. 9 is a flow diagram for an example method of determining a potential new location for a type of point of interest in accordance with aspects of the disclosure.

### DETAILED DESCRIPTION

The technology is generally directed to determining unmet business and service needs in a geographic region. The unmet need may be a market failure in that the population of the geographic region is not optimally served by local businesses, services, or points of interest. The unmet needs may be determined based on a failure score. The failure score may be based on navigational routes to the business, service, or points of interest and/or queries for the business, service, or points of interest. The navigational routes and queries may be aggregated by the type of business, service, or points of interest. The type of business, service, or points of interest may be a category of business, service, or point of interest such as clothing retail, yoga instruction, food stores, gas stations, restaurants, mechanics, arcade, movie theater, roller rink, etc. Based on the aggregated navigational routes and queries for the type of business, service, or points of interest, a number of factors may be determined, such as an average distance traveled to the type of business, service, or points of interest, a number of queries for the type of business, service, or points of interest, an average distance determined to travel to the type of business, service, or points of interest, a time of day of the navigation or query, etc. The factors may be weighted and used to determine the failure score. The failure score may correspond to an unmet business, service, or points of interest need. For example, a higher failure score may indicate a greater need for the type of business, service, or points of interest in the geographic region.

For purposes of ease and clarity, as used herein, when referring to business(es), service(s), or point(s) of interest, business(es) will be used.

Businesses may use the determined unmet needs to identify a potential location for establishing a physical presence for their business. The establishment of new businesses in a geographic region with unmet needs may reduce the average travel time and/or travel costs for a user to travel to a business. For example, if there is a determined unmet business need in the geographic region, a business of that type may establish itself in that region, thereby reducing the travel time and cost for users in that geographic region.

According to some examples, by aggregating navigational routes and/or queries by the time of day, or day of the week, the system may determine there is an unmet need for a type of business for a period of time of the day or a specific day of the week. The unmet business needs for a given time of day or day of the week may be used to determine whether to adjust hours to a given business of the type, open a new business of the type with those hours, be open on a certain day of the week, etc. For example, the failure score may indicate that during a particular time of day or on a particular day of the week, users may travel longer to a given business or service due to their location business or service being closed. In some examples, by aggregating navigational routes and/or queries by the time of day, the system may determine that there is an unmet need for gyms to be open late at night or for a hair salon to be open early in the morning. The business may determine, based on the failure score, that there may be value to changing their hours to be open on the day the local business is closed or to open a business with those hours.

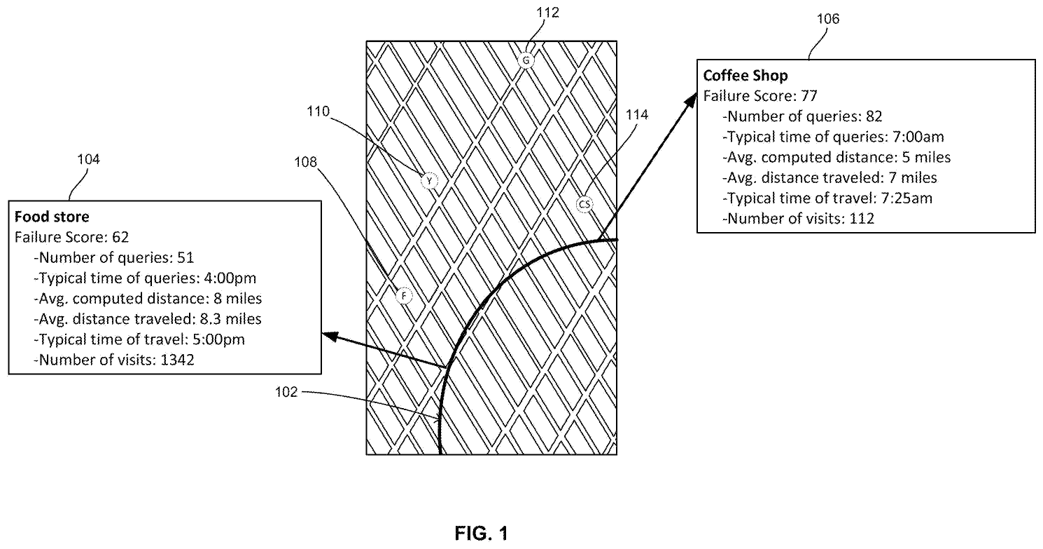

FIG. 1 illustrates example failure scores for a type of business in a geographic region. The failure score may indicate an unmet business need for the geographic region 102. For example, a high failure score may indicate that there is an unmet need for that type of business in the geographic region 102 whereas a low failure score may indicate that the need for that type of business in the geographic region 102 has been met. The failure score may be determined based on one or more factors, such as queries, navigational routes, and visits for the type of business.

A failure score for food stores 104 and coffee shops 106 within geographic region are shown. For example, a food store 108, yoga studio 110, gym 112, and coffeeshop 114 may be nearby geographic region 102 but are not located within geographic region 102. The failure score for food stores 104 and coffee shops 106 in geographic region 102 may be determined based on one or more factors. The factors may be. for example, travel metrics. Travel metrics may be a measurement, or value, of a characteristic of what is required to travel from a user's location to a destination. According to some examples, the travel metrics may include the number of queries for the type of business, the typical time and/or day the query is initiated. the average computed distance to the type of business, the average distance traveled to the type of business, the typical time of day and/or day of the week the travel is performed, the number of visits, travel costs, etc.

Queries may be for a business of a particular type and/or for a given business of the type of business in or nearby the geographic region 102. The queries may be initiated from the geographic region 102 or may be to identify businesses within geographic region 102. Additionally or alternatively, the queries may be a navigation query to obtain query routes. Query routes may be, for example, possible navigational routes to the given business or type of business. According to some examples, when the query route is not completed, the query route may be a failed navigational route.

Navigational routes may have a starting location and/or a destination located within the geographic region 102. Navigational routes may include a computed distance and a distance traveled. The computed distance may be the distance a user would travel to reach the destination using the navigational route. The computed distance may be determined based on a navigational query for a navigational route to the type of business or the particular business, such as by mapping out the navigational route and adding up distances of each segment along the route. The distance traveled may be the distance the user actually travels to reach the destination. The distance traveled may differ from the computed distance if, for example, the user took a different route, or if the user abandoned their plans to travel to the destination. According to some examples, when the navigational route is complete, the computed distance may substantially correspond to the distance traveled. According to some examples, when the user partially travels the navigational route, the distance traveled may be less than the computed distance. In such examples, the system may indicate that the navigational route was only partially traveled.

According to some examples, the system may determine the number of times the type of business in the geographic region 102 has been visited. For example, after verifying that users have authorized location sharing, the system may determine the number of visits to a business of the type of business in the geographic region. This may indicate which businesses of the type of business users in the geographical region are frequenting.

The system may aggregate the queries received based on the type of business to determine a total number of queries for the particular type of business. Additionally, for the type of business, the system may further aggregate the queries based on the time of day the queries were received, the day of the week the queries were received, query routes, query routes that completed, query routes that resulted in failed navigational queries, etc.

The system may aggregate the navigational routes with destinations including the type of business. For example, the system may aggregate the computed distance to the type of business to determine an average computed distance for the type of business. The average computed distance may be the average computed distance a user would have to travel away from geographic region 102 and/or travel to reach geographic region 102. In some examples, the system may aggregate the distance traveled to destinations including the type of business to determine the average distance traveled. In some examples, the system may determine the average distance traveled for completed routes to the type of business and/or the average distance traveled for partially completed routes to the type of business.

According to some examples, the system may further aggregate the navigational routes based on the time of day of the query for the navigational route, the day of the week of the query for the navigational route, the time of day the navigational route was traveled, the day of the week the navigational route was traveled, etc.

The system may aggregate the number of visits to the type of business. For example, the system may determine a total number of visits over a period of time. According to some examples, the system may aggregate the number of visits to the type of business based on the time of the visit, the day of the week of the visit, etc.

The system may use the aggregated queries and navigational routes to determine the failure score. A weight may be applied to each factor when determining the failure score. The weight may correspond to a degree of reliability of the factor. For example, a completed navigational route may have a higher degree of reliability as compared to a partially completed navigational route.

The failure score may be determined for a type of business in the geographic region 102. For example, the type of business may be clothing retail stores, convenience stores, gas stations, food stores, gyms, restaurants, mechanics, locksmiths, etc. According to some examples, the type of businesses may be more granular. For example, gyms may be further separated into yoga studios, gymnastic studios, weightlifting, kick-boxing, etc. Restaurants may be further separated based on the type of food, such as fast food, Italian, Mexican, etc., or atmosphere, such as family-friendly, fancy, etc.

The failure score may provide an indication of an unmet business need in the geographic region 102. A low failure score may indicate that the business need has been sufficiently met for the geographic region. In one example, users from geographic region 102 typically travel, on average, five miles to reach a yoga studio, and users from another geographic region also typically travel, on average, five miles to reach a yoga studio. There are 1,000 queries for a yoga studio in the geographic region 102 and fifty-five queries for a yoga studio in the other geographic region. In this example, as the typical average distance traveled to a yoga studio is five miles within geographic region 102 and the other geographic region, the unmet business need may be determined based on the number of queries. Based on there being more queries for a yoga studio within geographic region 102, geographic region 102 may have an unmet business need for a yoga studio.

According to some examples, based on the failure score for a type of business, the system may determine one or more candidate locations within geographic region 102 for the type of business that may results in an improvement of the failure score and/or one or more travel metrics, such as the average distance traveled, computed distance, etc. In some examples, the candidate locations may reduce fuel consumption, travel time, fuel emission, transit time, travel expenses, etc. for users.

FIG. 1 illustrates example failure scores for food stores 104 and coffee shops 106 within geographic region 102. For example, a food store 108, yoga studio 110, gym 112, and coffeeshop 114 may be nearby geographic region 102 but are not located within geographic region 102. The failure score for food stores 104 and coffee shops 106 in geographic region 102 may be determined based on queries originating from geographic region 102, queries for the type of business within geographic region 102. navigational routes originating from geographic region 102, and/or navigational routes to a destination within geographic region 102. The queries and navigation routes may be for a business of the type of business, e.g., coffee shops and food stores. The system may aggregate the queries and navigational routes, as described above and herein, to determine the failure score for the type of business.

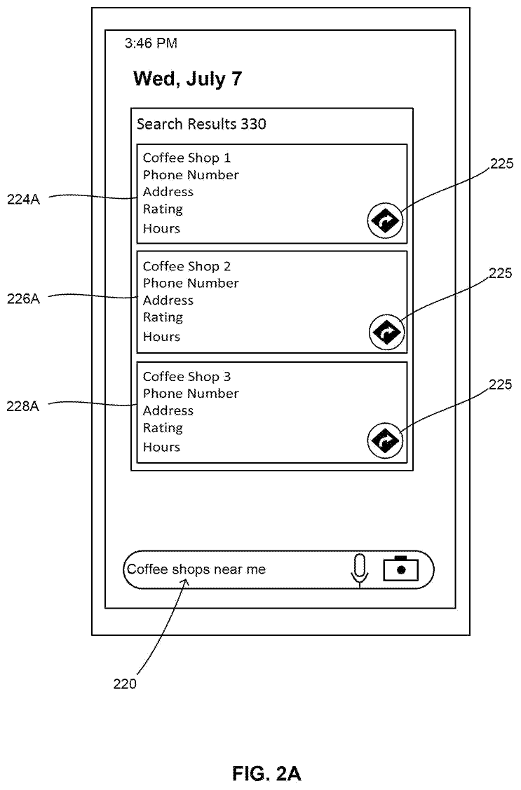

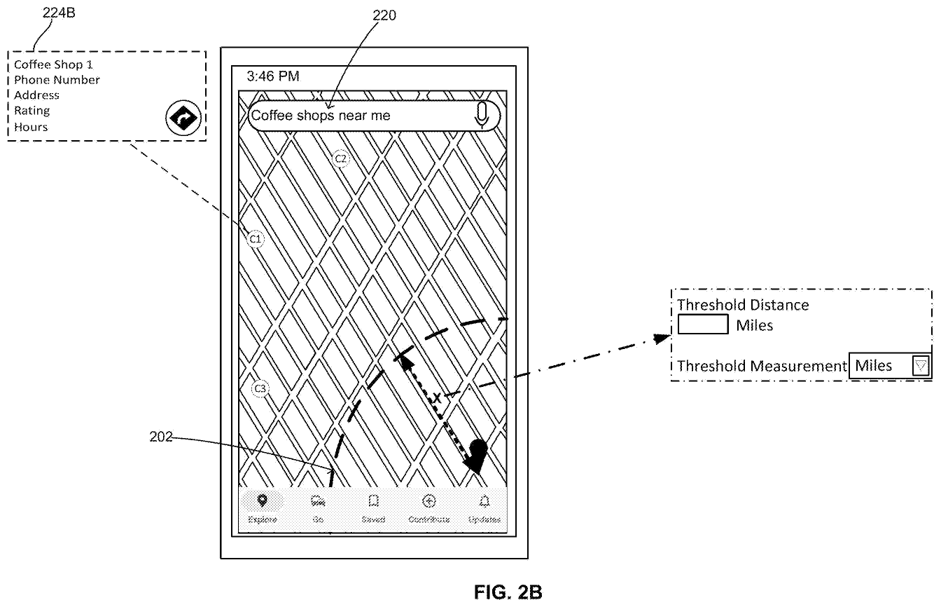

FIGS. 2A and 2B illustrate an example query for a type of business. A user may submit a query 220 to identify one or more businesses of the type of business in a particular geographic region or nearby the geographic region. According to some examples, the query 220 may be initiated from the geographic region. For example, after verifying that the user has authorized location sharing, the system may determine the location of the device submitting the query. In some examples, the system may use the location of the device to identify the geographic region, identify businesses responsive to the query, etc. The geographic region may be, for example, predefined based on neighborhoods, towns, cities, counties, states, etc. According to some examples, the geographic region may be predefined based on square feet, meters, miles, etc. According to other examples, the geographic region may be defined by arbitrary designations on a map. Additionally or alternatively, the geographic region may be defined based on the location of the user.

In some examples, the geographic region may be defined based on a threshold distance from the current location of the user. For example, as shown in FIG. 2B. a perimeter defining the geographic region 202 may be determined based on a threshold distance “X” from the current location 230 of the user. According to some examples, the threshold distance “X” may be set based on inputs received from the user. For example, the system may receive an input to change or adjust the threshold distance “X”. In some examples, the user's device may execute an application for determining a failure score. The application may provide a menu option, pop-up 227. or an overlay allowing the user to adjust the threshold distance “X”. As shown, the user may adjust the threshold distance “X” by providing a numerical input for the threshold distance “X” in miles. In some examples. the pop-up 227 may include a drop down menu. sliding scale, radio button, etc. as a way to select or set the threshold distance “X”. According to some examples, the threshold distance “X” may be set based on an estimated travel time. For example, the threshold distance “X” may correspond to a distance a user can drive in thirty minutes. Therefore, pop-up 227 for setting the threshold distance “X” in miles is merely an example and is not intended to be limiting.

The queries for the type of business may be aggregated to determine a total number of queries for a particular type of business. The type of business may be a category of business, such as clothing retail. electronics retail. food stores, gyms, restaurants, etc. According to some examples, the system may aggregate queries based on more granular categories. such as coffee shops for restaurants or yoga studios for gyms. After aggregating queries based on type of business, the system may determine a total number of searches for the particular type of business. The total number of searches for the type of business may provide an indication of an unmet business need for that particular type of business. For example, a greater number of queries initiated from the geographic region for the particular type of business may indicate that users from that geographic region have a greater interest in that type of business whereas a lower number of queries may indicate that there is little interest in that type of business.

According to some examples, the queries may be aggregated based on a lifetime number of queries for the particular type of business, a predefined period of time, a day of the week of the query, a time of day of the query, etc.

The lifetime number of queries may be a total number of searches the system has received for that type of business, regardless of how much time has passed since the query was received.

The predefined period of time may be, for example, a day, week, month, year, etc. The predefined period of time may be adjusted by the business owner, user, or entity determining whether there is an unmet need for the particular type of business. By aggregating the number of queries for a predefined period of time, the owner, user, or entity may be able to determine whether the unmet need has occurred recently. has been fulfilled recently, is ongoing, etc.

Aggregating the queries based on the time of the day and/or day of the week the query was received may indicate a time of day or day of the week users are most interested in the particular type of business. For example, if the system receives a greater number of queries for “smoothies near me” on Thursday afternoons as compared to Tuesday mornings, businesses in or around the geographic region may use this information to adjust business hours to meet the needs of users wanting smoothies on a Thursday afternoon. In another example, if the system receives a greater number of queries for a pharmacy after business hours, such as between 8 p.m. and 8 a.m. as compared to during business hours, businesses may use this information to meet the needs of the users. For example, business may determine that there is an unmet need for a pharmacy open 24 hours.

The query 220 may be for “coffee shops near me.” As shown in FIG. 2A, the query may be made through a search engine. The query 220 may originate from the geographic region. In response to the query 220, the system may provide a response including search results 222. The search results 222 may be provided in a list. The search results 222 may include an identification of businesses of the type of business in the geographic region or nearby the geographic region. In some examples, the search results 222 may include information 224A, 226A, 228A for Coffee Shop 1, Coffee Shop 2, and Coffee Shop 3, respectively. The information 224A, 226A, 228A, collectively information 224, may include the phone number, address, rating, hours, etc. for Coffee Shops 1-3. According to some examples, the information 224 may include an indication of the distance from the current location of the user.

In some examples, information 224 may include a link 225. The link may initiate a navigational query to the respective Coffee Shop. For example, in response to receiving an input corresponding to a selection of the link, the system may provide a query route. The query route may be a navigational route to the business of the type of business. For example, if the system receives an input corresponding to the selection of link 225 for Coffee Shop 1, the system may provide a query route from the current location of the user to Coffee Shop 1.

As shown in FIG. 2B, the query 220, “coffee shops near me”, may be made through a mapping application. In FIG. 2B, the search results may be provided on a map. For example, the results may include an indication C1, C2, C3 corresponding to the location of Coffee Shops 1-3, respectively. The map may, additionally or alternatively, include an indication of the current location 230 of the user.

According to some examples, the system may receive an input corresponding to the selection of indication C1, C2, C3. As shown in FIG. 2B, the system received an input corresponding to the selection of indication C1. The mapping application that received the query may provide a menu option, pop-up, or an overlay providing information 224B for Coffee Shop 1. Similar to information 224A, the information may include the phone number, address, rating, hours, etc. for Coffee Shop 1. According to some examples, the information 224B may include an indication of the distance from the current location 230 of the user to Coffee Shop 1. In some example, information 224B may include a link 225 which, when selected, may cause the mapping application to provide a query route, or navigational route, from the current location 230 of the user to the location of Coffee Shop 1.

As shown in FIGS. 2A and 2B, the query 220 may have been received by the system at 3:46 PM on a Wednesday. The system may determine, after verifying that the user has authorized location sharing, that the query 220 was initiated from within geographic region 202. The system may use a context of the query when aggregating the queries for the type of business initiated from within geographic region 202. Examples of such context can include date and time. For example, the system may aggregate the queries to determine a number of queries received at a particular time of day or a number of queries received at a particular day of the week for types of businesses within geographic region 202. According to some examples, a greater number of queries initiated from within geographic region 202 for coffee shops at a given time or on a particular day of the week and/or a greater number of queries for coffee shops within geographic region 202 at a particular time or a particular day of the week may indicate there is an unmet need for coffee shops in geographic region 202 at a particular time or a particular day of the week.

FIGS. 2A and 2B illustrate the query submitted using a search engine and a mapping application. However, the query may be submitted using a home assistant, device assistant, etc. Further, FIGS. 2A and 2B are examples where the queries are initiated within the geographic region. However, the queries may originate from outside of the geographic region and may be for business of a type of business within the geographic region. FIGS. 2A and 2B are merely examples of types of queries and the location of where the query originates and, therefore, are not intended to be limiting.

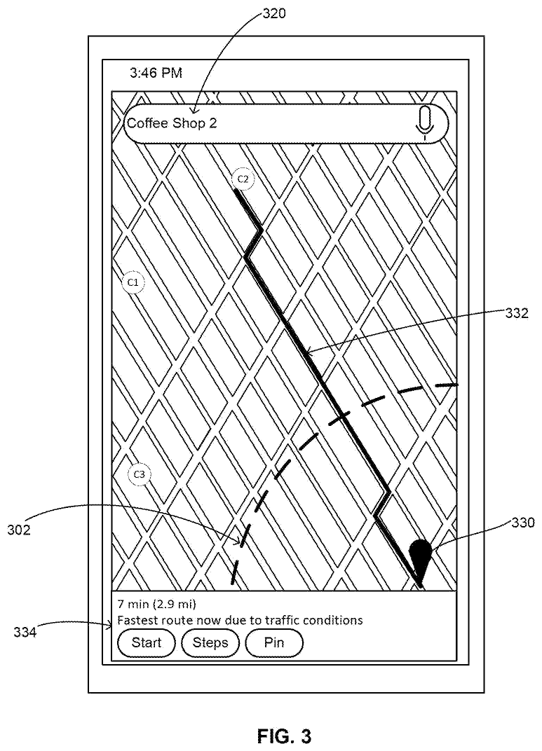

FIG. 3 illustrates an example navigational query. For example, users may submit navigational queries from a navigational or mapping application to obtain possible navigational routes to a business of the type of business. After verifying that the user has authorized location sharing. the system, in response to a navigational query, may provide query routes. Query routes may be navigational routes to the business of the type of business. For example, the starting location of the query route may be the current location of the user and the destination may be the business.

The navigational query 320 may be for a particular business, such as Coffee Shop 2, of the type of business, such as coffee shops. In response to the navigational query 320, the system may provide query route 332 to the particular business. For example, query route 332 may be a navigational route from the current location 330 of the user to the location C2 of Coffee Shop 2. In addition to the query route 332, or as an alternative, information 334 pertaining to the query route 332 may be provided in response to the navigational query 320. The information 334 may include, for example, the computed distance (2.9 miles). estimated travel time (7 minutes), and route details, such as it being the fastest route, most eco-friendly. avoiding tolls, etc.

Information 334 may. additionally or alternatively. include selectable options pertaining to query route 332, such as a start button, a steps button, and a pin button. When an input corresponding to the selection of the start button is received. navigation from the current location 330 to C2 may begin. When an input corresponding to the selection of the steps button is received, a sequence of navigational steps for query route 332 may be displayed as a pop-up, overlay, etc. When an input corresponding to the pin button is received, the query route 332 may be saved for easy access and/or retrieval at a later time.

In some examples, and as discussed above with respect to FIGS. 2A and 2B. navigational queries may be completed after a query for businesses of the type of business. For example, after a user submits a query for coffee shops near them and receives results indicating that Coffee Shops 1-3 are nearby, the user may submit a navigational query to receive a navigational route to one or more of the results.

According to some examples, the navigational queries may include failed navigational queries. Failed navigational queries may be queries that resulted in a navigational route that was generated but was not traveled by the user. In some examples, a failed navigational query may indicate that a user intended to visit the type of business, but ultimately did not reach the intended destination. For example, the failed navigation query may include uncompleted routes, such as when the system generates a navigational route from the user's current location to the given business, but the user never starts navigating to the given business. According to some examples, a failed navigation route may include a partially completed navigation route, such as when the user starts navigating to the given business but does not complete the navigation. The uncompleted and/or partially completed navigation routes may be aggregated as part of determining the failure score.

Navigational queries, including failed navigational queries, may be aggregated based on the type of business to determine a total number of query routes for a particular type of business. According to some examples, navigational queries may be aggregated based on the starting location of the query route being within the geographic region 302 or the destination of the query route being within the geographic region 302.

According to some examples, search queries and navigational queries may be aggregated together to determine a total number of queries for the type of business. In such an example, the total number of queries would include both the number of searches for the type of business and the number of query routes generated to the type of business.

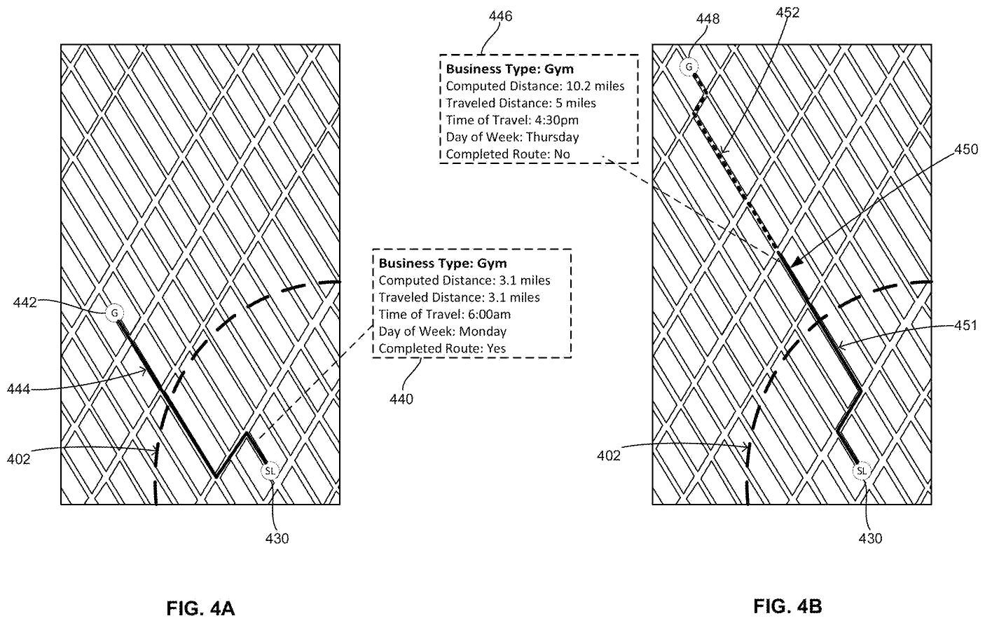

FIGS. 4A and 4B are example navigational routes to businesses of a type. The navigational routes may include a starting location or a destination in the geographic region 402. The destination may be, for example, a given business of the type of business. After verifying that the user has authorized the system to obtain location information, such as navigational routes, the system may use the queried routes, completed routes, and partially completed routes to determine an average computed distance and/or average distance traveled. According to some examples, the computed distance and average distance traveled to the type of business may be used to determine the failure score for the type of business in the geographic region 402.

The computed distance may be determined based on a query for a navigational route. For example, the computed distance may be the distance the user would travel to reach the destination using the navigational route. According to some examples, the computed distance may be the distance between the starting location and the destination, whether along the navigational route and/or as a direct line between the starting location and the distance location. To determine an average computed distance, the system may average the computed distance for the navigational routes aggregated for the type of business.

The distance traveled may be, for example, the distance the user actually travels to reach the destination. According to some examples, such as when the user completes the navigational route, the distance traveled may substantially correspond to the computed distance. In another example, such as when the user partially travels the navigational route, the distance traveled may be less than the computed distance. In examples where the user only partially travels the navigational route, the distance traveled for that navigational route may have an indication that the navigational route was not completed. According to some examples, the system may exclude partially traveled navigation routes when determining the average distance traveled to reach the business of the particular type. Additionally, or alternatively, when determining the average distance traveled, the system may determine a first average for completed routes and a second average for partially completed routes.

The system may use factors, or travel metrics, to determine candidate locations for the type of business. For example, the system may use an average distance traveled, average computed distance, time of day, day of week, number of visits, etc. to determine a failure score. If the failure score indicates that there is an unmet need for the type of business in the geographic region, the system may determine candidate locations within the geographic region that decrease the failure score and/or improve travel metrics. Improving travel metrics may be, in some examples, a reduction in the measurement of what is required to travel from the user's location to the destination. For example, an improved travel metric may be a reduction in the average distanced travel, travel time, etc. The candidate locations may provide benefits to users in and nearby the geographic region by reducing fuel consumption, travel time, fuel emission, travel costs, etc.

FIG. 4A illustrates an example completed navigation route 444. The navigation route 444 has a starting location 430 located within geographic region 402 and a destination 442 located outside of geographic region 402. After verifying that the user has authorized location sharing, the system may receive information 440 pertaining to navigation route 444. For example, the information 440 may include the type of business, computed distance, a traveled distance, the time the travel was completed, the day of the week the travel was completed, and an indication of whether the navigational route was completed.

The system may use information 440 to aggregate the navigational route with other navigational routes for the same type of business. For example, the system may aggregate the navigational routes to determine a total number of navigational routes to the type of business. In some examples, the system may further aggregate the navigational routes to determine an average computed distance, an average distance traveled, how often the travel occurs at a certain time or day and/or day of the week, how often the navigational routes to the type of business are completed, etc. By aggregating the navigational routes based on completion, time of day, day of week, computed distance, distance traveled, etc., the system may identify unmet needs for a certain geographic region, certain times of day, certain days of the week, etc.

FIG. 4B illustrates an example partially completed navigation route 450. A partially completed navigation route 405 may be, for example, a navigation route in which a user began traveling but stopped before reaching the destination. The partially completed navigation route 450 may have a completed route portion 451 and an uncompleted route portion 452. The complete route portion 451 may be the portion of navigation route 450 that a user actually traveled while the uncompleted route portion 452 may be the portion of navigation route 450 that the user did not travel.

After verifying that the user has authorized location sharing. the system may receive information 446 pertaining to navigation route 450. Similar to information 440, information 456 may include, for example, the type of business, a computed distance, a traveled distance, the time the travel was completed. the day of the week the travel was completed, and an indication of whether the navigational route was completed. The system may use information 456 to aggregate the partially completed navigational routes. In some examples, the system may further aggregate the partially completed navigational routes to determine an average distance completed, an average distance not traveled, etc. Each of the averages may be used as a factor when determining the failure score for the type of business.

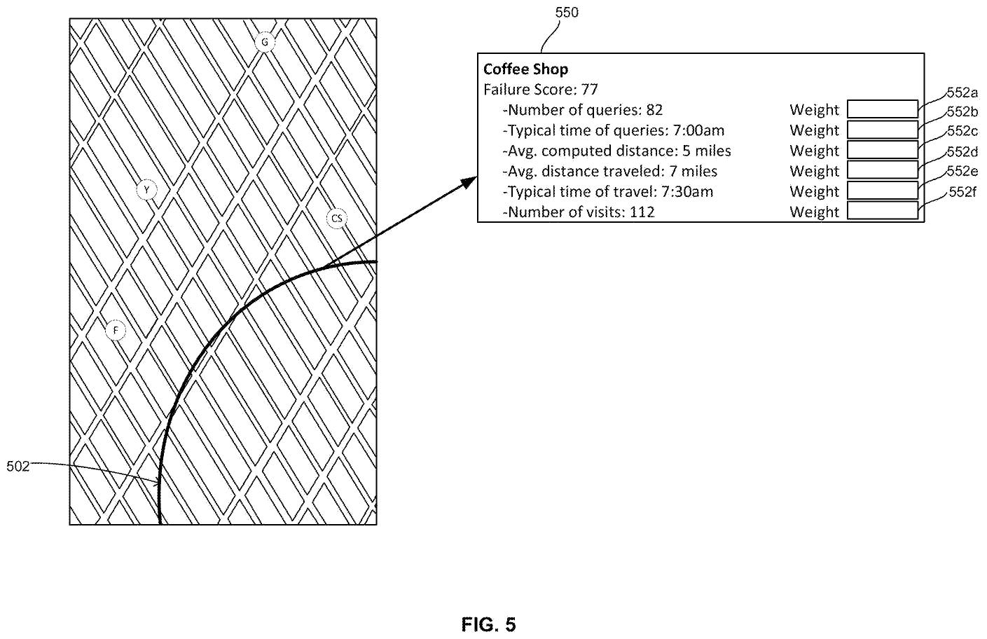

FIG. 5 illustrates an example failure score for a type of business in a given geographic region, such as a neighborhood, city, county, state, etc. The failure score may be used to determine unmet business needs. A high failure score may indicate an unmet business need for that type of business in the geographic region 502. A low failure score may indicate that the business need has been sufficiently met for the geographic region.

The failure score may be determined based on the one or more factors. Each factor may indicate a level of unmet need for the type of business. The factors may include an average computed distance, an average traveled distance for completed navigational routes, an average traveled distance for partially traveled routes, a number of queries for the type of business, a number of navigational queries, a number of failed navigational queries, a time of day of the travel, a time of day of the query, a number of visits to the type of point of interest in the geographical region, etc. For example, a user that is willing to travel a longer distance to the type of business may indicate there is a greater need for that type of business in the geographic region. A higher average distance computed for traveling to the type of business may indicate the lack of the type of businesses close to the geographic region. A time of day for travel or query may indicate that there is a demand for that type of business to be open during that time period. The greater the number of queries for the type of business may indicate a greater need for that business.

According to some examples, the failure score may be output as a pop-up 550, overlay, etc. Within the pop-up 550 may be inputs that allow businesses, users, entities, etc. to adjust how the failure score is determined. For example, each factor that is used to determine the failure score may be assigned a weight 552a-f. According to some examples, the weight may correspond to a degree of reliability of the factor, wherein the degree of reliability may be higher for completed navigational routes. For example, the distance traveled for a completed navigational route may have a larger weight assigned than the weight assigned to the distance traveled for a partially completed navigational route. A query route may have a greater weight assigned than the weight assigned to the number of search queries for the type of business. One example for determining the failure includes the following equation:

$$Failure Score ( Geographic Region , Type of Business ) = W 1 * Computed {Distance}_{Avg} + W 2 * Traveled {Distance}_{Avg} + W 3 * \#Queries + W 4 * Number of Visits + …$$

In the above equation, W1 corresponds to the weight 552c assigned to the average computed distance, W2 corresponds to the weight 552d assigned to the average distance traveled, W3 corresponds to the weight 552a assigned to the number of queries, and W4 corresponds to the weight 552b assigned to the number of visits. While four factors are shown in the equation, any number of factors may be included such that the equation includes more or less than four factors. Additionally, or alternatively, while four weights are shown, the weights applied to any of the factors may be the same or different. Further, while only four factors are shown, additional factors, such as the day of the week, factors pertaining to partially traveled routes, etc. may be included when determining the failure score.

According to some examples, the failure score of a food store in the geographic region may be determined. Using the example in FIG. 1, the average computed distance to the food store from the geographic region may be 8 miles, the average distance traveled to the food store from the geographic region may be 8.3 miles, the number of queries for the food store may be 51, and the number of visits to the food store may be 1.342. For the equation above, the weight W1 for the average computed distance may be 0.1, the weight W2 for the average distance traveled may be 0.3, the weight W3 for the number of queries may be 0.2, and the weight W4 for the number of visits may be 0.04 such that the equation to determine the failure score for the food store in the given geographic region is as follows:

$$\begin{matrix}Failure Score ( Geograhpic Region , Food Store ) = \\ ( 0.1 * 51 ) + ( 0.3 * 8 ) + ( 0.2 * 8.3 ) + ( 0.04 * 1342 ) = 62\end{matrix}$$

According to some examples, the weight 552a-f assigned to each factor may change based on the preferences of the business. For example, a business may place a greater emphasis and, therefore, may assign a larger weight to computed distances as compared to the number of search queries for the type of business. As shown, the business, user, entity, etc. may adjust the weight 552a-f for each factor by providing a numerical input for weights 552a-f. In some examples, the pop-up 550 may include a drop-down menu, sliding scale, radio button, etc. as a way to select or set the weight 552a-f for each factor.

Once a failure score has been calculated as above, the failure score may be compared against a predetermined failure score threshold. If the failure score exceeds the predetermined threshold, then it may be determined that there is an unmet need for that particular business type in the geographical area. The threshold may, for example, be a failure score of 50 or indeed any other number depending on the area. Once a new business of the desired business type has been established in the geographical area, the failure score can be re-calculated periodically (e.g. weekly, monthly, yearly etc.) to determine whether the establishment of that new business in the geographical area has been sufficient to bring the failure score down below the predetermined threshold. If the failure score remains above the predetermined threshold, then it may be concluded that there is still an unmet need for that business type in the geographical area and a second new business should be established.

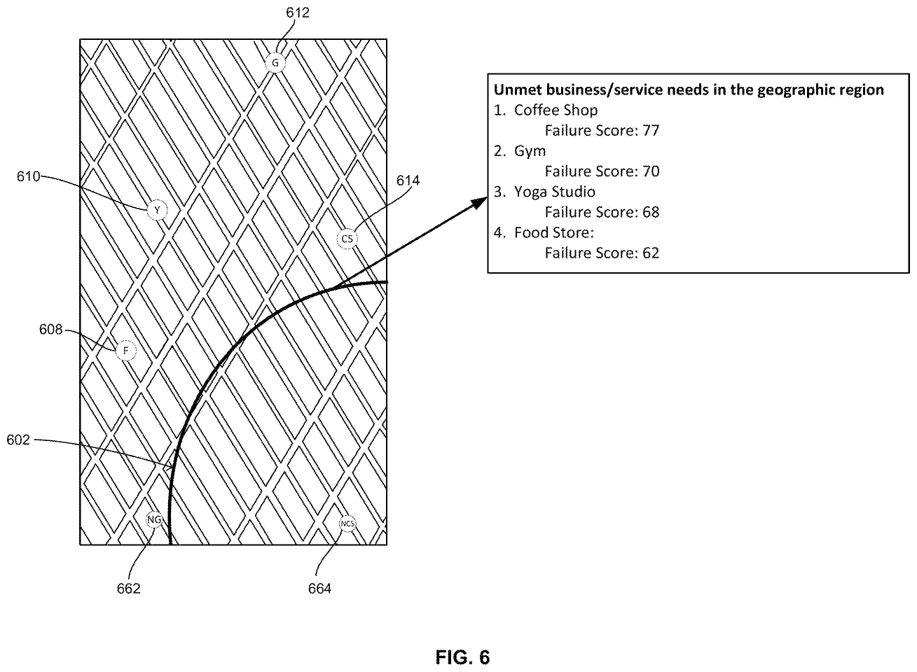

FIG. 6 illustrates an example in which the types of business have been ranked. The types of businesses may be ranked 660 based on their failure score. A higher rank may indicate a greater need for the type of business in the geographic region 602.

As shown, a coffee shop 614, gym 612, yoga studio 610, and food store 608 may be located nearby geographic region 602 but geographic region 602 does not include businesses of such types. The types of business, e.g., coffee shops, gyms, yoga studios, and food stores, may each have an associated failure score. The types of businesses may be ranked based on their failure score. For example, coffee shops may have the highest failure score and, therefore, is ranked number 1 whereas food stores have the lowest score and are ranked number 4, indicating that the geographic region 602 most needs a coffee shop and least needs a food store.

According to some examples, the system may, based on the failure score or based on one or more of the factors or travel metrics contributing to the failure score, determine one or more locations for a particular point of interest. Such a determination may, in some examples, be based on a single travel metric, without considering the failure score. The travel metrics may be, for example, the distance traveled, the time it takes to travel. the travel expense, such as money for gas or public transportation, carbon footprint. etc. The suggested location may be a location relative to the geographic region 602. For example, the suggested location may be a location within the geographic region 602 or nearby the geographic region. As shown in FIG. 6, the system may suggest a new gym location 662 nearby the geographic region 602 or a new coffee shop location 664 within the geographic region 602.

According to some examples, the system may identify new locations for the type of business based on location availability. For example, the system may identify buildings and/or property that is for sale or rent within, nearby, or relative to the geographic region 602. Based on the failure score and/or based on one or more of the factors contributing to the failure score, the system may suggest the new location for the type of business to be in the identified available buildings or property.

The determined one or more locations may be such that one or more of the factors is reduced or improved. For example, the system may. based on the calculated average distance traveled to reach a particular point of interest or business, determine a new location for the particular point of interest or business, the new location resulting in an objective reduction of the calculated average distance traveled. In some examples, the geographic region 602 may be defined based on a distance from the current location of the user. For example, the geographic region 602 may be defined based on a radius of 10 miles around the user. If the calculated average distance traveled to reach the point of interest or business is 25 miles. the suggested new location may be a location where the calculated average distance traveled would be 15 miles, thereby resulting in an objective reduction of the average time traveled. In such an example, the suggested new location may be located nearby, or relative to, the geographic region 602 but not within the geographic region 602.

In another example, the system may, based on the calculated average computed distance to reach a particular point of interest or business, determine a new location for the particular point of interest or business, the new location resulting in an objective reduction of the computed distance.

While the above examples have discussed average distance traveled and average computed distance as travel metrics, the system may instead or additionally base the determination of a new location on average transit time, average travel cost or other variable. As such, the system may determine a new location for the particular point of interest or business that objectively reduces the average transit time and/or average travel cost. Travel metrics thus include one or more of average distance traveled, average computed distance, average transit time and average travel cost.

While the calculation of a single new location has been discussed, the system may provide a plurality of candidate locations in a particular region which would result in an improvement of the assessed factor. For example, the system may, for a particular business or point of interest, provide a plurality of locations in a particular location which would reduce the calculated average travel distance.

As such, by determining one or more new location(s) resulting in an improvement in one or more travel metrics (such as average distance traveled or computed distance), the system beneficially determines improved locations for points of interest or businesses that objectively provide an average reduction in fuel consumption, travel time, fuel emission, transit time, travel cost and/or distance traveled for users. For example, if the travel metric is distance traveled, an improved value of the travel metric may be a reduction in the average distance traveled. In some examples, where the travel metric is average transit time, an improved value of the travel metric may be a reduction in the average travel time. In some examples, if the travel metric is the average speed traveled, an improvement value of the travel metric may be a greater average speed traveled. If the travel metric is average miles per gallon, the value of the travel metric may be improved if the average miles per gallon increases. While a single travel metric has been discussed in the above examples, the determination of a new location may be based on multiple travel metrics.

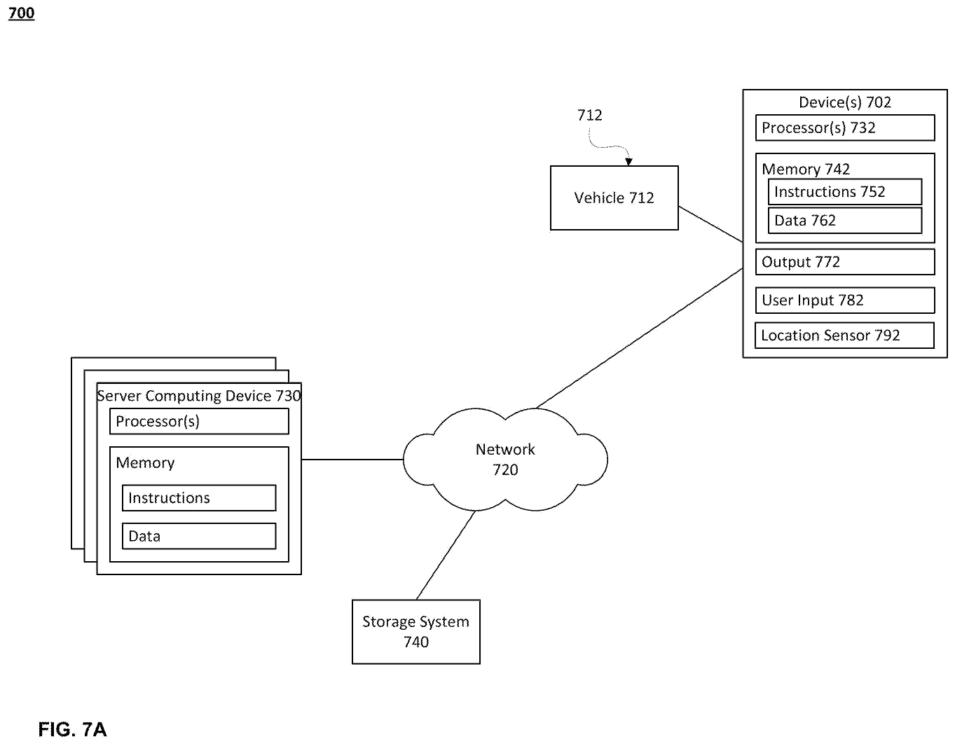

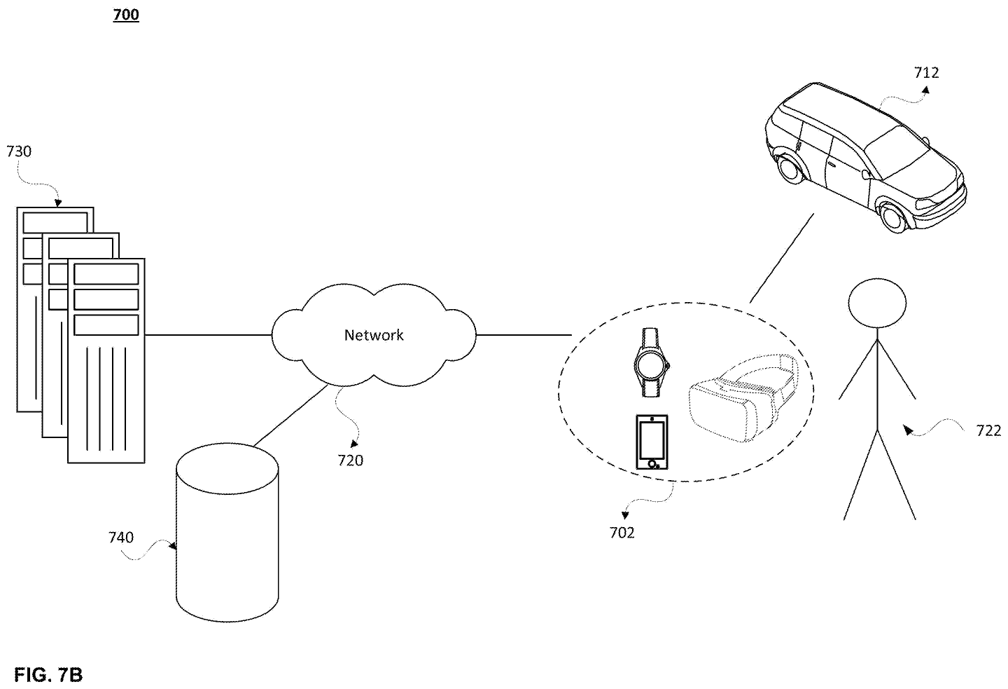

FIG. 7A illustrates an example system 700 in which the features described above may be implemented. It should not be considered limiting the scope of the disclosure or usefulness of the features described herein. In this example, system 700 may include device(s) 702, vehicle(s) 712. server computing device 730, storage system 740, and network 720.

Each of devices 702 may include one or more processors 732, memory 742, data 762 and instructions 752. Each of devices 702 may also include an output 772, user input 782, and location sensor 792. The devices 702 may be any device that includes a location sensor 792, such as a smart phone, tablet, laptop, smart watch, AR/VR headset, smart helmet, etc., as shown in FIG. 7B.

Memory 742 of devices 702 may store information that is accessible by processor 732. Memory 742 may also include data that can be retrieved, manipulated or stored by the processor 732. The memory 742 may be of any non-transitory type capable of storing information accessible by the processor 732, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. Memory 742 may store information that is accessible by the processors 732, including instructions 752 that may be executed by processors 732, and data 762.

Data 762 may be retrieved, stored or modified by processors 732 in accordance with instructions 752. For instance, although the present disclosure is not limited by a particular data structure, the data 762 may be stored in computer registers, in a relational database as a table having a plurality of different fields and records, XML documents, or flat files. The data 762 may also be formatted in a computer-readable format such as, but not limited to, binary values, ASCII or Unicode. By further way of example only, the data 762 may comprise information sufficient to identify the relevant information, such as numbers, descriptive text, proprietary codes, pointers, references to data stored in other memories (including other network locations) or information that is used by a function to calculate the relevant data.

The instructions 752 can be any set of instructions to be executed directly, such as machine code, or indirectly, such as scripts, by the processor 732. In that regard, the terms “instructions.” “application.” “steps.” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The one or more processors 732 may include any conventional processors, such as a commercially available CPU or microprocessor. Alternatively, the processor can be a dedicated component such as an ASIC or other hardware-based processor. Although not necessary, computing devices 702 may include specialized hardware components to perform specific computing functions faster or more efficiently.

Although FIG. 7A functionally illustrates the processor, memory, and other elements of devices 702 as being within the same respective blocks, it will be understood by those of ordinary skill in the art that the processor or memory may actually include multiple processors or memories that may or may not be stored within the same physical housing. Similarly, the memory may be a hard drive or other storage media located in a housing different from that of the devices 702. Accordingly, references to a processor or device will be understood to include references to a collection of processors or devices or memories that may or may not operate in parallel.

Output 772 may be a display, such as a monitor having a screen, a touch-screen, a projector, or a television. The display 772 of the one or more computing devices 702 may electronically display information to a user via a graphical user interface (“GUI”) or other types of user interfaces. For example. as will be discussed below, display 772 may electronically display a map interface identifying relevant destinations, routine trips, or one or more travel metrics based on a specified starting location.

The user input 782 may be a mouse, keyboard, touch-screen, microphone, or any other type of input. The user input may receive the user's authorization to use the location sensor 792 to obtain location information for the travel metrics. For example, the user can select particular applications for which to allow location services, particular times during which location services can be enabled, or other permissions or limitations for the location services.

The location sensor 792 may be, for example, a global positioning system (“GPS”) sensor, wireless communications interface, etc. The location sensor 792, when enabled by the user, may provide a rough indication as to the location of the device. According to some examples, when authorized by the user, the location sensors may provide location information indicating relevant destinations or routine trips.

The location information may be stored locally on the device 702 or navigational system, such as part of an application or integrated into vehicle 712. In some examples, the location information may be shared to a remote location, such as a remote server 730 or storage system 740. According to some examples, the location information may be used to identify types of destinations visited and the frequency such that the system does not require or obtain the specific destination location.

The devices 702 can be at various nodes of a network 720 and capable of directly and indirectly communicating with other nodes of network 720. Although three (3) computing devices are depicted in FIG. 7A. it should be appreciated that a typical system can include one or more computing devices, with each computing device being at a different node of network 720. The network 720 and intervening nodes described herein can be interconnected using various protocols and systems, such that the network can be part of the Internet. World Wide Web, specific intranets, wide area networks, or local networks. The network 720 can utilize standard communications protocols, such as WiFi, Bluetooth, 4G, 5G, etc., that are proprietary to one or more companies. Although certain advantages are obtained when information is transmitted or received as noted above, other aspects of the subject matter described herein are not limited to any particular manner of transmission.

In one example, system 700 may include one or more server computing devices 730 having a plurality of computing devices, e.g., a load balanced server farm, that exchange information with different nodes of a network for the purpose of receiving, processing and transmitting the data to and from other computing devices. For instance, one or more server computing devices 730 may be a web server that is capable of communicating with the one or more client computing devices 702 via the network 720. In addition, server computing device 730 may use network 720 to transmit and present information to a user of one of the other computing devices 702 or a passenger of a vehicle. In this regard, vehicles 712 may be considered client computing devices. Server computing device 730 may include one or more processors, memory, instructions, data, location sensors, etc. These components operate in the same or similar fashion as those described above with respect to computing devices 702.

As shown in FIG. 7B, each device 702 may be a personal computing device intended for use by a respective user 722, and have all of the components normally used in connection with a personal computing device including one or more processors (e.g., a central processing unit (CPU)), memory (e.g., RAM and internal hard drives) storing data and instructions, an output, such as a display (e.g., a monitor having a screen, a touch-screen, a projector, a television, or other device such as a smart watch display that is operable to display information), and user input devices (e.g., a mouse, keyboard, touchscreen or microphone). The devices may also include a camera for recording video streams, speakers, a network interface device, and all of the components used for connecting these elements to one another. Devices 702 may be capable of wirelessly exchanging or obtaining data over the network 720.

Although the client computing devices may each comprise a full-sized personal computing device. they may alternatively comprise mobile computing devices capable of wirelessly exchanging data with a server over a network such as the Internet. By way of example only, devices 702 may be mobile phones or devices such as a wireless-enabled PDA, smartphones, a tablet PC, a wearable computing device (e.g., a smartwatch, AR/VR headset, smart helmet, etc.), or a netbook that is capable of obtaining information via the Internet or other networks.

User 722 may operate a respective vehicle 712. The vehicle 712 may include a location sensor. In some examples, vehicle 712 may include an integrated navigation system. According to some examples, the navigation system may be integrated into a user's 722 respective device 702. In yet another example, the device 702 or vehicle 712 may execute a mapping application that provides maps or directions, identifies a user's location, etc.

Any use of location information or travel history of a user 722 is authorized by the respective user. For example, the user 722 may provide authorization to an application for determining failure scores by setting certain permissions for the application. The authorization may be for the application to access one or more databases or sub-databases in the memory of the device, vehicle, remote server, etc. According to one example, the user may select specific sub-databases to which the application is granted access. For instance, the user may grant access to the location history database but not the calendar archive database.

Vehicles 712 may include a computing device (not shown). The computing device may include one or more components similar to devices 702, such as one or more processors, memory, data, instructions, a display, a user input, etc. According to some examples, vehicles 712 may include a perception system for detecting and performing analysis on objects external to the vehicle such as other vehicles, obstacles in the roadway, traffic signals, signs, trees, etc. Additionally or alternatively, the perception system may determine whether the vehicle is in motion or parked. For example, the perception system may include lasers, sonar, radar, one or more cameras, or any other detection devices which record data which may be processed by a computing device (not shown) within vehicles 712. In the case where the vehicle is a small passenger vehicle such as a car, the car may include a laser mounted on the roof or other convenient locations as well as other sensors such as cameras, radars, sonars, and additional lasers (not shown).

Storage system 740 may store various types of information. For instance, the storage system 140 may store data or information related to a user's location information, such as the user's travel history, places of interest for the user, relevant destinations, etc. In some examples, storage system 740 may store data or information related to destinations, points of interest (“POI”), services, or businesses for retrieval in response to a request to determine failure scores. As used herein, POIs may include any location, or destination, that a user can visit, such as an office building, apartment complex, home address, barber shop, nail salon, big-box store, local hardware store, park, green space, restaurant, theater venue, amusement park, shopping center, etc.

Storage system 740 may store map data. This map data may include, for instance, locations of POIs, locations of driving lanes, parking lanes, designated parking areas, no parking zones, drop off locations, etc. Map data may also include locations, road names, road configurations, etc.

According to some examples, storage system 740 may store data or information related to a user's 722 location information after receiving authorization from the user 722. The authorization may be, for example, provided by setting permissions for the system to access location information and travel history. For example, a user may be provided with controls allowing the user to make an election as to both if and when systems, programs, or features described herein may enable collection of location information, and if the user is sent content or communications from a server. In addition, certain data may be treated in one or more ways before it is stored or used, so that personally identifiable information is removed. The user may have control over what information is collected about the user, how that information is used, and what information is provided to the user. The user's 722 location information or travel history may be used to identify, or determine, a user's 722 completed navigation routes or partially completed navigation routes.

While FIGS. 7A and 7B illustrate a single user 722 and their respective device(s) 702 and vehicle 712, it should be understood that there may be multiple users and their respective devices and vehicles. The location information and travel history of each user may be used to determine a respective user's travel history. Each user's location information and travel history may be aggregated and used to illustrate failure scores for a given area, such as a neighborhood, town, city, county, state, etc.

Each respective user provides authorization for an application to access their location information and travel history. The user may set permissions for the application to indicate what location information and travel history the application may access. The location information may be stored locally on the user device. In some examples, the location information from the user device(s) and/or navigational applications may be shared with and, therefore, stored by one or more servers. In yet another example, the location information may be captured and stored by navigational applications. The location information and travel history may only be shared with and stored by servers after a user authorizes the sharing of location information and travel history.

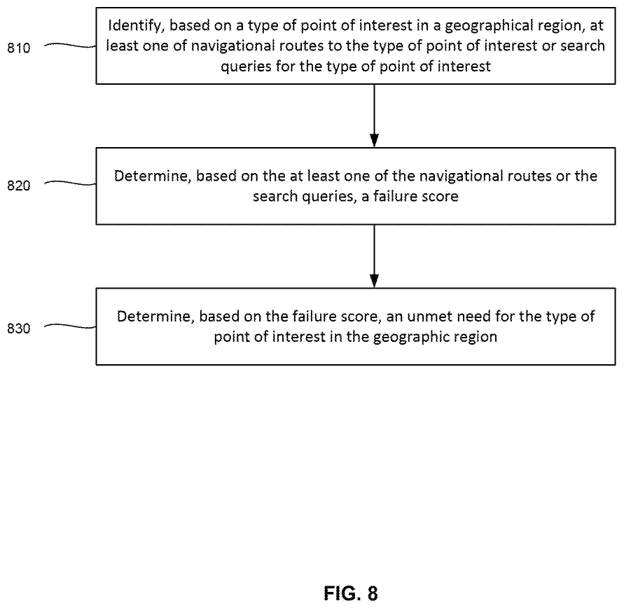

FIG. 8 illustrates an example method for determining an unmet need for a type of point of interest in a geographic region. The following operations do not have to be performed in the precise order described below. Rather, various operations can be handled in a different order or simultaneously, and operations may be added or omitted.

In block 810, the system may identify, based on a type of point of interest in a geographical region, at least one navigational route to the type of point of interest or search queries for the type of point of interest. The type of point of interest may correspond to a category of point of interest. For example, the categories may include retail, restaurants, family entertainment, home services, etc. In some examples, the categories may be more specific, such as food stores, gas stations, movie theaters, arcades, plumbers, mechanics, etc.

According to some examples, an origin or destination of the navigational routes may be in the geographic region. The navigational routes may include one or more completed navigational routes or partially completed navigational routes. Additionally or alternatively, the search queries may be for the type of interest in the geographic region or the search queries may originate from the geographic region.

In block 820, the system may determine, based on at least one of the navigational routes or the search queries, a failure score. Determining the failure score may include determining one or more factors related to the search queries for the type of point of interest or navigational routes to the type of point of interest. According to some examples, the factors may include an average computed distance, an average traveled distance for completed navigational routes, an average traveled distance for partially traveled routes, a number of queries for the type of business, a number of navigational queries, a number of failed navigational queries, a time of day of the travel, a time of day of the query, or a number of visits to the type of point of interest in the geographical region. In some examples, the factors may be weighted. The failure score may be determined based on the weighted factors.

In block 830, the system may determine, based on the failure score, an unmet need for the type of point of interest in the geographic region. For example, a high failure score may indicate there is an unmet need for that type of point of interest in the geographic region whereas a low failure score may indicate the need for that type of point of interest has been met in the geographic region.

According to some examples, the system may determine respective failure scores for other types of points of interest in the geographic region. The system may rank the types of point of interest based on their respective failure scores. According to some examples, the type of point of interest that is ranked highest may have the greatest unmet need in the geographic region.

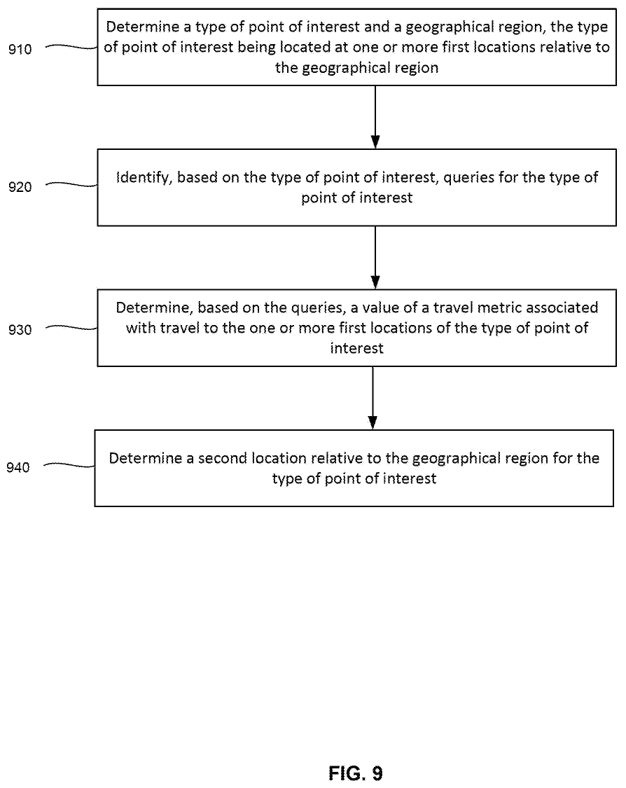

FIG. 9 illustrates an example method for determining a potential new location for a type of point of interest in a geographic region. The following operations do not have to be performed in the precise order described below. Rather, various operations can be handled in a different order or simultaneously, and operations may be added or omitted.

In block 910, the system may determine a type of point interest and a geographical region. The type of point of interest may be located at one or more first locations relative to the geographical region. For example, the type of point of interest may be located in or nearby the geographical region. The type of point of interest may correspond to a category of point of interest.

In block 920, the system may identify, based on the type of point of interest, queries for the type of point of interest. The queries may include at least one of search queries or navigational queries. The results of the queries may include navigational routes. Each navigational route may include a different starting location. The starting location may be within the geographical region or the starting location may be outside of the geographical region. In examples where the starting location is outside of the geographical region, the destination of the navigational route may be within the geographical region. According to some examples, the navigational routes may include one or more completed navigational routes or partially completed navigational routes.

In block 930, the system may determine, based on the navigational routes, a value of a travel metric associated with travel to the one or more first locations of the type of point of interest. The travel metric may be, for example, a measurement or value of a characteristic of what is required to travel from the user's location to the destination. In some examples, the travel metrics may correspond to the one or more of the factors used to determine a failure score. For example, the travel metrics may include an average distance traveled, an average computed distance, an average transit time, a number of visits, a time of day of travel, a day of week of travel, an average travel cost, etc. Determining the value of the travel metric may include aggregate the computed distance, distance traveled, time of travel, travel time, etc. to determine the average and/or total for a given travel metric.

In block 940, the system may determine a second location relative to the geographical region for the type of point of interest. According to some examples, a value of the travel metric associated with travel to the second location may be improved as compared to the value of the travel metric associated with travel to the one or more first locations.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples. Further, the same reference numbers in different drawings can identify the same or similar elements.

1. A method, comprising:
determining, by one or more processors, a type of point of interest and a geographical region, the type of point of interest being located at one or more first locations relative to the geographical region;
identifying, by the one or more processors based on the type of point of interest, queries for the type of point of interest;
determining, by the one or more processors based on the queries, a value of a travel metric associated with travel to the one or more first locations of the type of point of interest; and
determining, by the one or more processors, a second location relative to the geographical region for the type of point of interest,
wherein a value of the travel metric associated with travel to the second location is improved as compared to the value of the travel metric associated with travel to the one or more first locations.

2. The method of claim 1, wherein the queries are at least one of search queries or navigational queries.

3. The method of claim 1, wherein the travel metric comprises one or more of average distance traveled, average computed distance, average transit time, a number of visits, a time of day of the travel, a day of week of the travel, and average travel cost.

4. The method of claim 1, wherein the queries include navigational routes to the type of point of interest, each navigational route comprises a different starting location.

5. The method of claim 4, wherein a starting location of each navigational route is within the geographical region or a destination of each navigational route is within the geographical region.

6. The method of claim 4, wherein the navigational routes include one or more completed navigational routes or partially completed navigational routes.

7. The method of claim 1, wherein the type of point of interest corresponds to a category of point of interest.

8. The method of claim 1, wherein the queries may originate from the geographical region or are for the type of point of interest within the geographical region.

9. A system, comprising:
one or more processors, the one or more processors configured to:
determine a type of point of interest and a geographical region, the type of point of interest being located at one or more first locations relative to the geographical region;
identify, based on the type of point of interest, queries for the type of point of interest;
determine, based on the queries, a value of a travel metric associated with travel to the one or more first locations of the type of point of interest; and
determine a second location relative to the geographical region for the type of point of interest,
wherein a value of the travel metric associated with travel to the second location is improved as compared to the value of the travel metric associated with travel to the one or more first locations.

10. The system of claim 9, wherein the queries are at least one of search queries or navigational queries.

11. The system of claim 9, wherein the travel metric comprises one or more of average distance traveled, average computed distance, average transit time, a number of visits, a time of day of the travel, a day of week of the travel, and average travel cost.

12. The system of claim 9, wherein queries include navigational routes to the type of point of interest, each navigational route comprises a different starting location.

13. The system of claim 12, wherein a starting location of each navigational route is within the geographical region or a destination of each navigational route is within the geographical region.

14. The system of claim 12, wherein the navigational routes include one or more completed navigational routes or partially completed navigational routes.

15. The system of claim 9, wherein the type of point of interest corresponds to a category of point of interest.

16. The system of claim 9, wherein the queries originate from the geographical region or are for the type of point interest within the geographical region.

17. One or more non-transitory computer-readable medium storing instructions, which when executed by one or more processors, cause the one or more processors to:
determine a type of point of interest and a geographical region, the type of point of interest being located at one or more first locations relative to the geographical region;
identify, based on the type of point of interest, queries for the type of point of interest;
determine, based on the queries, a value of a travel metric associated with travel to the one or more first locations of the type of point of interest; and
determine a second location relative to the geographical region for the type of point of interest,
wherein a value of the travel metric associated with travel to the second location is improved as compared to the value of the travel metric associated with travel to the one or more first locations.

18. The one or more non-transitory computer-readable medium of claim 17, wherein the queries are at least one of search queries or navigational queries.

19. The one or more non-transitory computer-readable medium of claim 17, wherein the travel metric comprises one or more of average distance traveled, average computed distance, average transit time, a number of visits, a time of day of the travel, a day of week of the travel, and average travel cost.

20. The one or more non-transitory computer-readable medium of claim 17, wherein queries include navigational routes to the type of point of interest, each navigational route comprises a different starting location.

21-24. (canceled)
